(19) United States
(12) Patent Application Publication
(10) Pub. No.: US 2010/0191949 A1
(43) Pub. Date: Jul. 29, 2010

(54) INFORMATION PROCESSING TERMINAL AND FALSIFICATION VERIFICATION METHOD

(75) Inventors: Takeshi Shishido, Yokohama-shi (JP); Jun Anzai, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/666,615

(22) PCT Filed: Jul. 26, 2007
(86) PCT No.: PCT/JP2007/064669

§ 371 Date: Dec. 23, 2009

(51) Int. Cl. G06F 9/24

(52) U.S. Cl. 713/2

(57) ABSTRACT

An information processing terminal that performs falsification verification at the time of bootstrapping thereof includes: a state sensor that senses a connection of an external connector or a data reception via the external connector, to judge whether or not a program stored in the information processing terminal is in a rewritable state; a flag storage that stores a flag referred to at the time of bootstrapping of the information processing terminal therein; a flag controller that turns on the flag according to a judged result that the program is in the rewritable state by the state sensor to record the turn-on flag in the flag storage; and a falsification verifier that judges whether or not it is necessary to carry out falsification verification according to a status of the flag, and performs falsification verification of the program only in the case in which the flag in the flag storage is turned on, at the time of bootstrapping of the information processing terminal.

### TECHNICAL FIELD

The present invention relates to an information processing terminal and a falsification verification method for performing falsification verification according to a situation at the time of bootstrapping thereof.

### BACKGROUND ART

Information processing terminals including cellular telephones, PDAs, and the like perform falsification verification of programs before bootstrapping of their operating systems as one step of their bootstrapping sequences executed when the information processing terminal is turned on or the like. Depending on a performance of a terminal, it takes a second-scale time until the falsification verification is terminated. Moreover, falsification verification is performed every time an information processing terminal is activated. Therefore, it is necessary for a user of an information processing terminal to wait for the termination of falsification verification and the completion of bootstrapping of its operating system while the information processing terminal is turned on to move into an operable state.

With a technology disclosed in Patent Document 1, before executing its operating system software, the consistency of the operating system software is proved, and a state of a flag indicating the presence or absence of the consistency of the operating system software is stored, thereby establishing a secure processing environment between the information processing terminal and an external device. In this way, it is possible to determine whether a secure processing environment exists or not with reference to a flag.

With a technology disclosed in Patent Document 2, a control flag indicating whether or not the test of the normality of an information processing apparatus should be carried out is stored, and the content of the control flag is determined at the time of turning on the information processing apparatus, to control to execute or omit a test according to its determined result. However, the control flag is allowed to rewrite by an operation by an operator of the information processing apparatus.

Patent Document 1: JP-A-2006-221631

Patent Document 2: JP-A-60-5346

### DISCLOSURE OF THE INVENTION

### Problems to be Solved by the Invention

As described above, if falsification verification is performed every time an information processing terminal is activated, the bootstrapping time gets longer by that much, thus it is preferable to be able to shorten a bootstrapping time. As one method for achieving shortening of a bootstrapping time, the technology of Patent Document 2 may be utilized. However, in this technology, a control flag for determining whether a test of the normality (falsification verification) is executed or omitted is not allowed to change unless there is an operation by an operator. Therefore, a technology that a flag is automatically changed in the case in which there is a possibility that a program is rewritten, to perform falsification verification according to the flag at the time of bootstrapping of an information processing terminal, is desired.

An object of the present invention is to provide an information processing terminal and a falsification verification method for performing falsification verification only in the case in which there is a possibility that a program is rewritten at the time of bootstrapping thereof.

### Means for Solving the Problems

The present invention provides an information processing terminal that performs falsification verification at the time of bootstrapping thereof including: a state sensor that senses a connection of an external connector or a data reception via the external connector, to judge whether or not a program stored in the information processing terminal is in a rewritable state; a flag storage that stores a flag referred to at the time of bootstrapping of the information processing terminal therein; a flag controller that turns on the flag according to a judged result that the program is in the rewritable state by the state sensor to record the turn-on flag in the flag storage; and a falsification verifier that judges whether or not it is necessary to carry out falsification verification according to a status of the flag, and performs falsification verification of the program only in the case in which the flag in the flag storage is turned on, at the time of bootstrapping of the information processing terminal.

In the information processing terminal, the state sensor judges a case in which an external memory device is connected to the information processing terminal, a case in which the information processing terminal receives data greater than or equal to a predetermined amount via the external connector, and a case in which the information processing terminal continuously performs reception of data less than or equal to a predetermined amount for a predetermined number of times via the external connector, as the rewritable states of the program.

The information processing terminal includes a battery mounting detector that senses mounting of a battery to output a signal indicating the mounting of the battery, and the flag controller turns on the flag stored in the flag storage according to the signal output from the battery mounting detector.

The information processing terminal includes a storage that stores information on date and time when the last falsification verification performed in the past is performed, and the flag controller turns on the flag in the case in which a predetermined time passes from a date and time shown by the information on date and time.

The information processing terminal includes an authentication processor that authenticates the external connection to the information processing terminal, and wherein, in the case in which the authentication processor authenticates that the external connected to the information processing terminal is valid, the state sensor judges that the program is not in the rewritable state.

The present invention provides a falsification verification method including: a state sensing step of sensing a connection of an information processing terminal to an external connector or a data reception via the external connector, to judge whether or not a program stored in the information processing terminal is in a rewritable state; a flag control step of turning on a flag according to a judged result that the program is in the rewritable state by the state sensing step; and a falsification verification step of judging whether or not it is necessary to carry out falsification verification according to a status of the flag, and performing falsification verification of the program only in the case in which the flag is on at the time of bootstrapping of the information processing terminal.

### ADVANTAGEOUS EFFECTS OF THE INVENTION

In accordance with the information processing terminal and the falsification verification method according to the present invention, because falsification verification is performed only in the case in which there is a possibility that a program is rewritten at the time of bootstrapping thereof, falsification verification is not performed every time the information processing terminal is activated. Therefore, it is possible to shorten a bootstrapping time according to a status of a flag. Further, because a status of a flag is changed on the basis of a judged result by a state sensor, it is possible to set a status of a flag according to a falsification-possible status. In this way, it is possible to provide a bootstrapping sequence satisfying both of the bootstrapping time and the security.

### BRIEF DESCRIPTION OF THE DRAWINGS

FIG. 1 is a block diagram showing an information processing terminal according to an embodiment.

FIG. 2 is a flowchart showing operations of the information processing terminal when the information processing terminal is turned on.

FIG. 3 is a flowchart showing operations of the information processing terminal when a connection of an external I/F or a data reception via the external I/F is sensed.

### DESCRIPTION OF REFERENCE NUMERALS AND SIGNS

101 Program storage

103 External I/F connection sensor

105 Flag controller

107 Flag storage

109 Falsification verifier

### BEST MODE FOR CARRYING OUT THE INVENTION

Hereinafter, an embodiment of the present invention will be described with reference to the drawings.

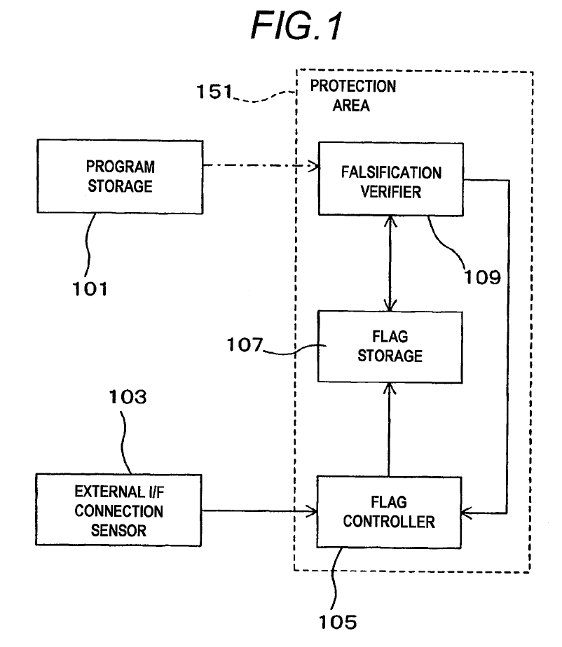

FIG. 1 is a block diagram showing an information processing terminal according to an embodiment. As shown in FIG. 1, the information processing terminal of the present embodiment includes a program storage 101, an external I/F connection sensor 103, a flag controller 105, a flag storage 107, and a falsification verifier 109. Note that program data for flag-control executed by the flag controller 105, data stored in the flag storage 107, and program data for falsification verification executed by the falsification verifier 109 are stored in formats protected by encryption or the like in a predetermined storage area 151. Although not shown in the drawing, in the information processing terminal of the present embodiment, a terminal to which a USB device is connected, a slot into which a memory card is inserted, and means for performing wired or wireless communication with an external device are provided.

The program storage 101 is a rewritable recording medium, to store plain text program data executed in the information processing terminal therein. The external I/F connection sensor 103 senses a connection of an external I/F such as a USB device or a memory card to the information processing terminal, or a data reception via an external I/F through wired or wireless communication, to judge whether or not the program stored in the program storage 101 is in a rewritable state. The details of the rewritable state of the program will be described later.

The flag controller 105 controls a status of a flag stored in the flag storage 107 on the basis of a judged result by the external I/F connection sensor 103. The control of a state of flag means changing a status of the flag stored in the flag storage 107 such as turning on or off the flag. The flag storage 107 stores the flag to which the falsification verifier 109 refers at the time of bootstrapping of the information processing terminal. There are two types of flag statuses, which are “flag ON” or “flag OFF.” The “flag ON” indicates a state in which the flag is on, and the “flag OFF” indicates a state in which the flag is not on.

The falsification verifier 109 judges whether or not it is necessary to carry out falsification verification according to a status of the flag stored in the flag storage 107 at the time of bootstrapping of the information processing terminal. Only in the case in which a status of the flag is “flag ON,” the falsification verifier 109 performs falsification verification of the program stored in the program storage 101. Note that the falsification verification of a program is to verify whether or not the program is falsified.

Hereinafter, the rewritable state of the program stored in the program storage 101 will be described in detail. The external I/F connection sensor 103 judges the states listed below as rewritable states of the program.
(1) A state in which a USB device such as a USB flash memory is connected to the information processing terminal.
(2) A state in which a memory card is connected to the information processing terminal.
(3) A state in which the information processing terminal receives data greater than or equal to a predetermined amount via an external I/F through wired or wireless communication.
(4) A state in which the information processing terminal continuously performs reception of data less than or equal to a predetermined amount at a predetermined number of times via an external I/F through wired or wireless communication.

When the information processing terminal moves into any one of states (1) to (4) described above, the external I/F connection sensor 103 sends a signal indicating that the program is in the rewritable state to the flag controller 105. The flag controller 105 changes the status of the flag stored in the flag storage 107 to “flag ON” according to this signal.

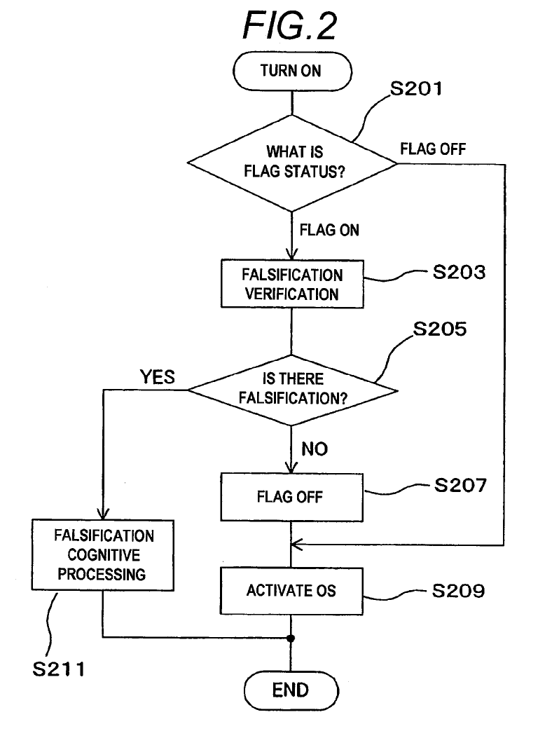

FIG. 2 is a flowchart showing operations of the information processing terminal when the information processing terminal of the present embodiment is turned on. As shown in FIG. 2, when the information processing terminal is turned on, the falsification verifier 109 judges whether or not it is necessary to carry out falsification verification according to a status of the flag stored in the flag storage 107 in step S201. When the status of the flag is “flag ON,” the process proceeds to step S203 to perform falsification verification, and when the status of the flag is “flag OFF,” falsification verification is not performed, and the process proceeds to step S209 to activate its operating system.

In step S203, the falsification verifier 109 performs falsification verification of the program stored in the program storage 101. Next, in step S205, as a result of the falsification verification in step S203, in the case in which the falsification verifier 109 judges that the program is not falsified, the process proceeds to step S207, and in the case in which the falsification verifier 109 judges that the program is falsified, the process proceeds to step S211.

In step S207, the falsification verifier 109 sends a signal indicating that there is no falsification to the flag controller 105, and the flag controller 105 changes the status of the flag stored in the flag storage 107 to “flag OFF” according to this signal. Next, the process proceeds to step S209, and the information processing terminal activates its operating system. On the other hand, in step S211, the information processing terminal does not perform bootstrapping of the operating system, but performs falsification cognitive processing such as causing an LED lamp to emit light or generating a buzzer sound.

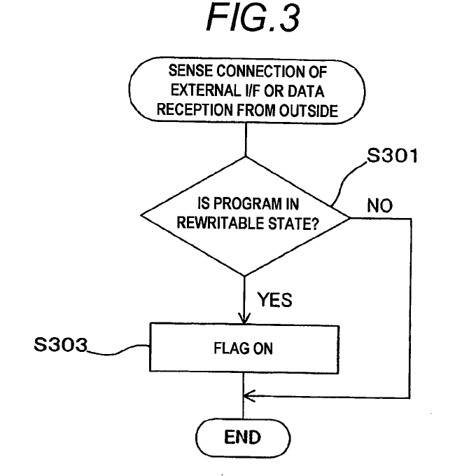

FIG. 3 is a flowchart showing operations of the information processing terminal of the present embodiment when a connection of an external I/F or a data reception via an external I/F is sensed. As shown in FIG. 3, when a connection of the external I/F or a data reception via the external I/F is sensed, in step S301, the external I/F connection sensor 103 judges whether or not the program stored in the program storage 101 is in a rewritable state. When the program is in the rewritable state, the process proceeds to step S303, and when the program is not in the rewritable state, nothing is performed.

In step S303, the external I/F connection sensor 103 sends a signal indicating that the program is in a rewritable state to the flag controller 105, and the flag controller 105 changes the status of the flag stored in the flag storage 107 to “flag ON” according to this signal.

In the above description, it is described that, when the external I/F connection sensor 103 judges that the information processing terminal is in a state shown in the above-described (1) to (4), the flag controller 105 changes the status of the flag to “flag ON.” Alternatively, the flag controller 105 may change the status of the flag even in a state other than the states (1) to (4). For example, when a battery is mounted into the information processing terminal, the flag controller 105 may change the status of the flag to “flag ON.” In this case, the information processing terminal includes a battery mounting detector (not shown) that senses mounting of the battery to output a signal indicating the mounting of the battery. The flag controller 105 changes the status of the flag to “flag ON” according to this signal output from the battery mounting detector.

Further, when a predetermined time passes from the last falsification verification performed in the past, the flag controller 105 may change the status of the flag to “flag ON.” In this case, the information processing terminal includes a storage (not shown) that stores information on date and time when the last falsification verification performed in the past is performed. When a predetermined time has passed from the date and time shown by the information on date and time with reference to information on date and time stored in this storage, the flag controller 105 changes the status of the flag to “flag ON.”

On the other hand, even if the external I/F connection sensor 103 judges that the information processing terminal is in the above-described state (1) (the state in which a USB device is connected to the information processing terminal), when the connected USB device has been authenticated, the external I/F connection sensor 103 may judge that the program is not in a rewritable state. In this case, the external I/F connection sensor 103 has an authentication processor (not shown) that senses the presence or absence of authentication for the connected USB device.

As described above, the information processing terminal of the present embodiment performs falsification verification at the time of bootstrapping thereof only when the status of the flag is “flag ON,” and does not perform falsification verification when there is no possibility that the program is falsified (i.e., at the time of “flag OFF”). In this way, because falsification verification is not performed every time the information processing terminal is activated, it is possible to shorten a bootstrapping time according to a status of the flag. Further, since a status of the flag is changed according to a connection of an external I/F to the information processing terminal or a data reception via an external I/F, it is possible to set a status of the flag according to a situation of falsification possibility. In this way, it is possible to provide a bootstrapping sequence satisfying both of the bootstrapping time and the security.

The present invention has been described in detail and with reference to the specific embodiment. It is clear to those skilled in the art that various changes and modifications can be made without any departure from the spirit and scope of the present invention.

### INDUSTRIAL APPLICABILITY

The information processing terminal and the falsification verification method according to the present invention are useful as an apparatus or the like that performs falsification verification only in the case in which there is a possibility that a program is rewritten at the time of bootstrapping thereof.

1. An information processing terminal that performs falsification verification at the time of bootstrapping thereof comprising:
a state sensor that senses a connection of an external connector or a data reception via the external connector, to judge whether or not a program stored in the information processing terminal is in a rewritable state;
a flag storage that stores a flag referred to at the time of bootstrapping of the information processing terminal therein;
a flag controller that turns on the flag according to a judged result that the program is in the rewritable state by the state sensor to record the turn-on flag in the flag storage; and
a falsification verifier that judges whether or not it is necessary to carry out falsification verification according to a status of the flag, and performs falsification verification of the program only in the case in which the flag in the flag storage is turned on, at the time of bootstrapping of the information processing terminal.

2. The information processing terminal according to claim 1, wherein the state sensor judges a case in which an external memory device is connected to the information processing terminal, a case in which the information processing terminal receives data greater than or equal to a predetermined amount via the external connector, and a case in which the information processing terminal continuously performs reception of data less than or equal to a predetermined amount for a predetermined number of times via the external connector, as the rewritable states of the program.

3. The information processing terminal according to claim 1, comprising
a battery mounting detector that detects mounting of a battery to output a signal indicating the mounting of the battery,
wherein the flag controller turns on the flag stored in the flag storage according to the signal output from the battery mounting detector.

4. The information processing terminal according to claim 1, comprising
a storage that stores information on date and time when the last falsification verification performed in the past is performed,
wherein the flag controller turns on the flag in the case in which a predetermined time passes from a date and time shown by the information on date and time.

5. The information processing terminal according to claim 1, comprising
an authentication processor that authenticates the external connection to the information processing terminal,
wherein, in the case in which the authentication processor authenticates that the external connected to the information processing terminal is valid, the state sensor judges that the program is not in the rewritable state.

6. A falsification verification method comprising:
a state sensing step of sensing a connection of an information processing terminal to an external connector or a data reception via the external connector, to judge whether or not a program stored in the information processing terminal is in a rewritable state;
a flag control step of turning on a flag according to a judged result that the program is in the rewritable state by the state sensing step; and
a falsification verification step of judging whether or not it is necessary to carry out falsification verification according to a status of the flag, and performing falsification verification of the program only in the case in which the flag is on at the time of bootstrapping of the information processing terminal.
